(19) United States
(12) Patent Application Publication
(10) Pub. No.: US 2006/0198088 A1
(43) Pub. Date: Sep. 7, 2006

(54) Display housing with filter medium retainer

(75) Inventors: Steven R. Anderson, Woodbury, MN (US); Jon A. Kirschhoffer, White Bear Lake, MN (US); Scott D. Gullicks, Apple Valley, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/074,119

(22) Filed: Mar. 7, 2005

(51) Int. Cl. G06F 1/16

(52) U.S. Cl. 361/681

(57) ABSTRACT

The present invention is a display housing for use with a display screen. The display housing includes a rear housing portion and a front frame connectable to the rear housing portion. The front frame defines an aperture through which the display screen is visible when the display screen is disposed between the front frame and the rear housing portion. The display housing also includes a retaining component for retaining a filter medium between the display screen and a front edge of the front frame.

### BACKGROUND OF THE INVENTION

The present invention relates to viewing devices and filter media for use with the viewing devices. In particular, the present invention relates to viewing devices having display housings that are capable of retaining filter media, where the filter media modify what a viewer sees.

Viewing devices, such as computer monitors and televisions, are available in a variety of models, such as cathode-ray tube (CRT) displays, liquid crystal displays (LCD), and plasma displays. The trend in the development of viewing devices is focused on providing lighter weight and thinner displays (e.g., LCD and plasma displays), which offer the benefit of portability. This is particularly true with respect to computer monitors, such as notebook computer displays.

A common drawback with viewing devices, particularly with computer monitors, is that physical problems, such as headaches, eye irritation, and even vision impairment, may result from extended use of the viewing devices. This is known as computer vision syndrome (CVS). One attempt to resolve this issue is with the use of filter media, which are typically provided in external filter devices. Various filter media can be used to reduce glare, improve contrast, protect screens or provide screen privacy. External filter devices typically include housing components that hold the filter media. The external filter devices are mounted to the display housings of viewing devices such that the filter media are disposed in front of the display screens. However, this presents an issue with many viewing devices, such as notebook computer displays, as such external filter devices may reduce the portability and ease of use of the notebook computers.

Additionally, external filter devices may not match the colors, materials, textures, and sizes of the individual displays to which the external filter devices are mounted. The external filter devices typically have generic colors (e.g., gray or off-white) and sizes (based on screen size), which may be noticeably different from the displays with which they are used. This reduces the aesthetic qualities of the displays when the external filter devices are mounted to them. Accordingly, there exists a need for a system to retain filter media with displays, which allows the aesthetic qualities and portability of the displays to be preserved.

### BRIEF SUMMARY OF THE INVENTION

The present invention is directed to a display housing for use with a display screen. The display housing includes a rear housing portion and a front frame connectable to the rear housing portion. The front frame defines an aperture through which the display screen is visible when the display screen is disposed between the front frame and the rear housing portion. The display housing also includes a retaining component for retaining a filter medium between the display screen and a front edge of the front frame.

### BRIEF DESCRIPTION OF THE DRAWINGS

FIG. 1 is a front perspective view of a notebook computer having a display of the present invention in use with a filter medium.

FIG. 2A is a front perspective view of the notebook computer, showing the filter medium being inserted through a right wall of the display.

FIG. 2B is a side perspective view of the display, further illustrating the embodiment of FIG. 2A

FIG. 2C is an expanded view of section 2C in FIG. 2B, showing an alternative embodiment of the display.

FIG. 2D is an expanded view of section 2C in FIG. 2B, showing a second alternative embodiment of the display.

FIG. 2E is an expanded view of section 2E in FIG. 2B, showing a third alternative arrangement of the display.

FIG. 2F is an expanded view of section 2E in FIG. 2B, showing a fourth alternative arrangement of the display.

FIG. 2G is a front view of an alterative embodiment of the filter medium.

FIG. 2H is a front view of a second alterative embodiment of the filter medium.

FIG. 2I is a front view of a third alterative embodiment of the filter medium.

FIG. 2J is a front view of a fourth alterative embodiment of the filter medium.

FIG. 3A is a front perspective view of the notebook computer, showing the filter medium being inserted through a top wall of the display.

FIG. 3B is a top perspective view of the display, further illustrating the embodiment of FIG. 3A.

FIG. 4A is a front perspective view of the notebook computer, showing the filter medium being inserted through guide rails of the display.

FIG. 4B is a front perspective view of the display, further illustrating the embodiment of FIG. 4A.

FIG. 4C is a sectional view of section 4C-4C in FIG. 4B.

FIG. 4D is a sectional view of section 4C-4C in FIG. 4B, showing an alternative embodiment of the display.

FIG. 4E is a sectional view of section 4C-4C in FIG. 4B, showing a second alternative embodiment of the display.

FIG. 4F is a front perspective view of the display, showing a third alternative embodiment of the display.

FIG. 4G is a sectional view of a section 4G-4G in FIG. 4B, showing another alternative embodiment of the display.

FIG. 5 is a front perspective view of the notebook computer, showing the filter medium being inserted into tabs of the display.

FIG. 6 is a front perspective view of the notebook computer, showing the filter medium being inserted into notches of the display.

FIG. 7A is a front perspective view of the notebook computer, showing a filter medium frame insert being connected to the display.

FIG. 7B is a front perspective view of alternative embodiment of the filter medium frame insert.

FIG. 7C is a side sectional view of the display, showing the alternative embodiment of the filter medium frame insert connected to the display.

FIG. 7D is a sectional view of section 7D-7D in FIG. 7A.

FIG. 8 is a front perspective view of the notebook computer, showing multiple filter media being inserted through a right wall of the display.

While the above-identified drawing figures set forth several embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale. Like reference numbers have been used throughout the figures to denote like parts.

### DETAILED DESCRIPTION

FIG. 1 is a front perspective view of notebook computer 10 in use with filter medium 12, where notebook computer 10 includes computer base 14 and an exemplary display 16 of the present disclosure. Computer base 14 may be any conventional notebook computer base, and can connect to display 16 in a conventional manner. Exemplary display 16 is a notebook computer display, and includes display housing 18 and screen 20. As discussed below, display housing 18 is capable of removably retaining filter medium 12 for use with notebook computer 10. This allows filter medium 12 to be used and removed when desired while preserving aesthetic qualities of notebook computer 10, and without the need of external filter mounting devices.

Display housing 18 includes rear housing portion 22 and front frame 24. Rear housing portion 22 can be a conventional rear housing portion of a notebook computer display. Front frame 24 is connected to rear housing portion 22, and includes top wall 26, bottom wall 28, left wall 30, and right wall 32, all of which define aperture 34 at the front of display 16.

In this exemplary embodiment, screen 20 is a conventional LCD display screen for a notebook computer, and is disposed between rear housing portion 22 and front frame 24. The screen 20 can be secured in the display housing 18 in a conventional manner. For example, screen 20 may be secured to rear housing portion 22, and front frame 24 may be used to support and protect the front edges of screen 20. Screen 20 is visible to a user through aperture 34. Alternatively, screen 20 can be secured to front frame 24, or it can be secured between front frame 24 and rear housing portion 22.

Filter medium 12 may be any suitable film for filtering the output of screen 20 or otherwise modifying what a viewer sees. Examples of suitable films for filter medium 12 include glare-reduction filters, contrast filters, privacy filters, static charge-dissipation filters, colored films, screen protection filters, and combinations thereof. Examples of suitable commercial filters for filter medium 12 include privacy filters commercially available from 3M Corporation, St. Paul, Minn. Filter medium 12 desirably exhibits dimensions in a plane parallel to screen 20 that extend at least completely across aperture 34.

As discussed in descriptions of the exemplary embodiments below, display housing 18 includes a retaining component (not shown in FIG. 1) for removably retaining filter medium 12 in display housing 18. As such, filter medium 12 can be removably retained in front of screen 20. This arrangement allows the output of screen 20 to be filtered without the need of an externally mounted filter device. In contrast, display housing 18 constructed according to the present disclosure can be part of notebook computer 10. As such, it may conveniently retain filter medium 12 even when notebook computer 10 is closed.

Moreover, retaining filter medium 12 within display housing 18 also allows filter medium 12 to be positioned relatively close to screen 20. However, care should be taken not to allow filter medium 12 to scratch or otherwise damage screen 20. Nonetheless, the close proximity is beneficial for a variety of filter media that are more effective when positioned close to screen 20. Filter medium 12 is preferably positioned within display housing 18 between screen 20 and a front edge of front frame 24. The front edge of front frame 24 is defined as an edge of front frame 24 that extends furthest from screen 20 in a direction perpendicular to screen 20. The actual distances between filter medium 12 and screen 20 may vary depending on the dimensions of display housing 18.

Additionally, display housing 18 is the actual display housing of display 16. In contrast to external display devices, display housing 18 may correspond in color, materials, texture, and size to computer base 14. As such, computer base 14 and display 16 appear to be uniformly manufactured, which preserves the aesthetic qualities of notebook computer 10.

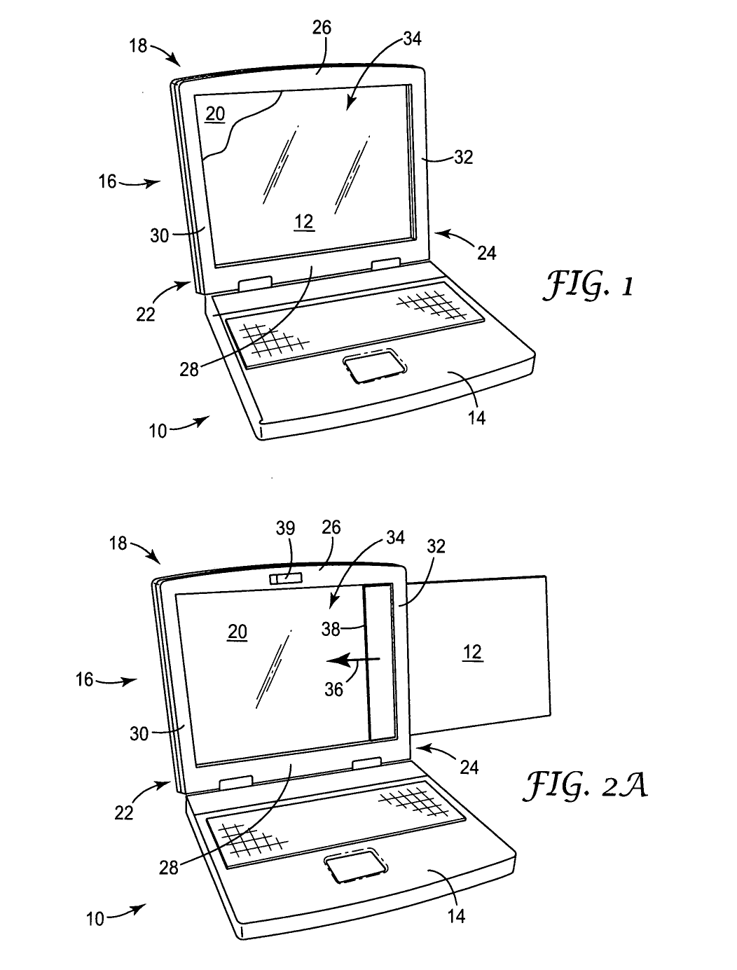

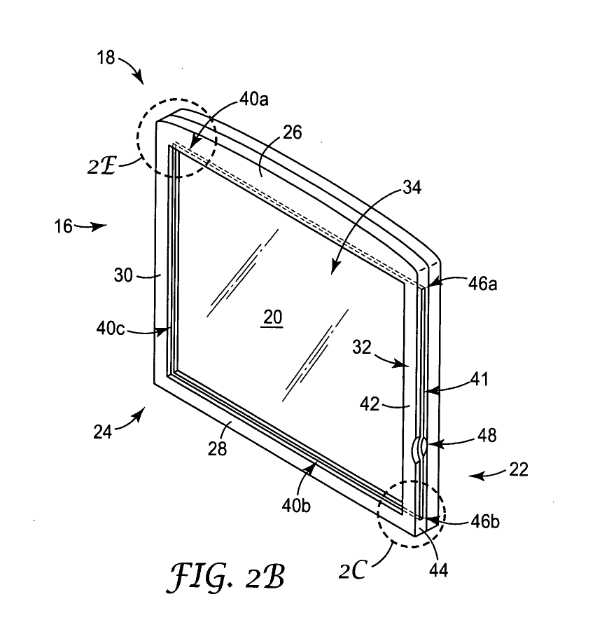

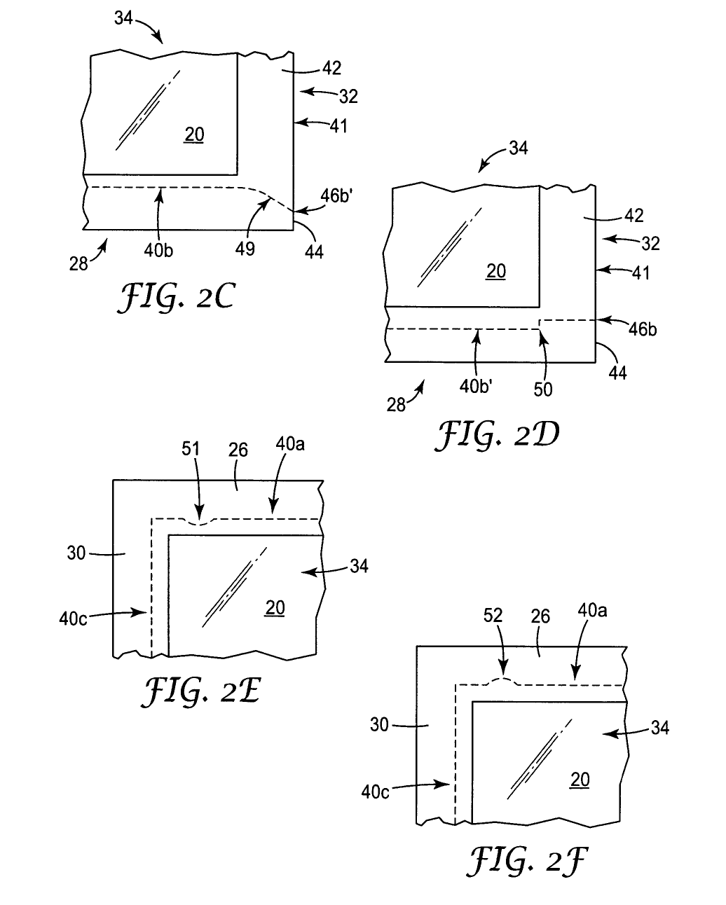

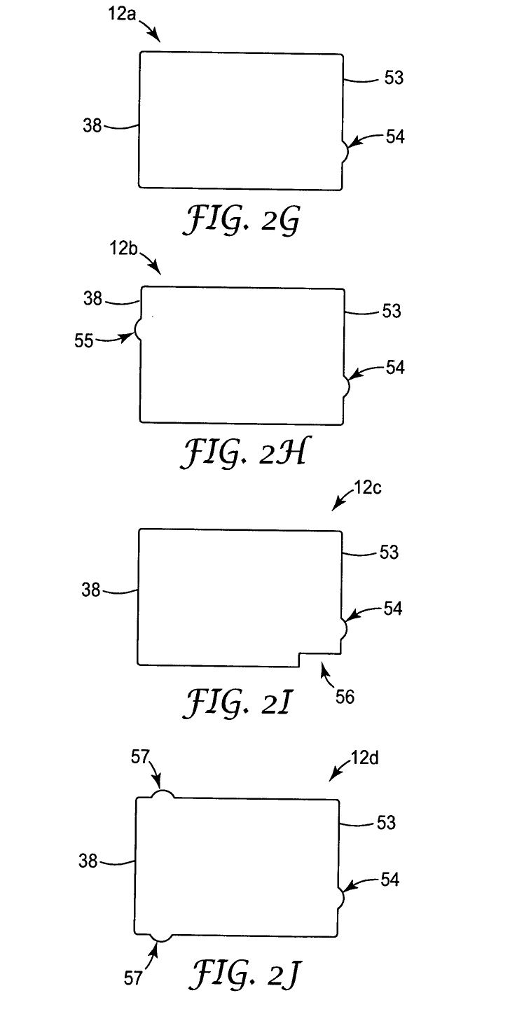

FIGS. 2A-8 illustrate different exemplary embodiments of the retaining component of display housing 18, which receives and removably holds filter medium 12 in display housing 18. FIG. 2A is a front perspective view of notebook computer 10, showing filter medium 12 being inserted through right wall 32 of front frame 24. This is noted by directional arrow 36. As shown, filter medium 12 includes leading edge 38. Leading edge 38 slides through right wall 32 and into aperture 34, until filter medium 12 is disposed in front of screen 20. In this embodiment, filter medium 12 may be removably retained in front frame 24, thereby allowing multiple filter media to be interchangeably used with display 16 or providing the user with the option of using no filter medium when desired. This increases the versatility of the present invention.

As further shown in FIG. 2A, top wall 26 of front frame 24 includes locking mechanism 39, which is a conventional notebook computer locking mechanism that latches to computer base 14 when notebook computer 10 is closed. The present embodiment is useful where locking mechanism 39 is located on top wall 26 of front frame 24. This prevents locking mechanism 39 from interfering with the insertion of filter medium 12.

FIG. 2B is a side perspective view of display 16, and further illustrates the embodiment of FIG. 2A. As shown, front frame 24 includes tracks 40a-40c and slot 41, all of which are integrally formed in front frame 24. Additionally or alternatively, slot 41 may be formed in rear housing portion 22, or between front frame 24 and rear housing portion 22. Tracks 40a-40c respectively extend along the inner perimeters of top wall 26, bottom wall 28, and left wall 30, within aperture 34 (track 40a is shown by phantom lines). Right wall 32 of front frame 24 includes front surface 42 adjacent aperture 34, and side surface 44 adjacent rear housing portion 22. Slot 41 extends through right wall 32 from side surface 44, and into aperture 34. Slot 41 includes top end 46a that aligns with track 40a and bottom end 46b that aligns with track 40b.

Filter medium 12 is inserted into front frame 24 by sliding leading edge 38 of filter medium 12 into slot 41. Filter medium 12 is then slid through right wall 32 at slot 41, and into aperture 34 along tracks 40a and 40b. Tracks 40a and 40b allow filter medium 12 to be inserted without contacting screen 20, which reduces the risk of scratching screen 20. Filter medium 12 is slid along tracks 40a and 40b until leading edge 38 of filter medium 12 reaches and enters track 40c. When fully inserted, filter medium 12 is disposed in front of screen 20, for example, for use as an optical filter, as discussed above. Additionally, the edges of filter medium 12 are hidden by front frame 24. As a result, filter medium 12 visually appears as part of display housing 18, which preserves the aesthetic qualities of display 16.

As further shown in FIG. 2B, display housing 18 also includes indentation 48 in rear housing portion 22 and front frame 24, at right wall 32. Indentation 48 allows a user to grip filter medium 12 for removal when filter medium 12 is retained in display housing 18. Indentation 48 is shown in FIG. 2B at an off-centered location between top end 46a and bottom end 46b of slot 41. As discussed below, the off-centered location is useful with certain filter media that have preferred orientations. For example, many filter media require a particular surface to face a user. In alternative embodiments, indentation 48 may be disposed at other locations along right wall 32 between top end 46a and bottom end 46b of slot 41 (e.g., centered).

The present embodiment may alternatively be arranged such that slot 41 extends through left wall 30 in lieu of right wall 32. In this arrangement, filter medium 12 is inserted from the left side of notebook computer 10, but otherwise functions in a similar manner to the right-side insertion discussed above.

FIGS. 2C and 2D are expanded views of section 2C in FIG. 2B, which illustrate alternative embodiments of track 40b and slot 41. As shown in FIG. 2C, bottom end 46b′ of slot 41 is not aligned with track 40b. This is in contrast to the embodiment discussed above in FIG. 2B, in which bottom end 46b is aligned with track 40b. Bottom end 46b′ is separated from track 40b by a slope 49, which provides an angled access to track 40b from slot 41. When filter medium 12 is inserted into slot 41, slope 49 guides leading edge 38 of filter medium 12 into track 40b. This arrangement provides a longer entrance for slot 41 along side surface 44, which reduces the alignment accuracy required to insert filter medium 12 into slot 41. A similar arrangement may be used with top end 46a of slot 41 and track 40a to further increase the length of slot 41 or with both the top and bottom ends of slot 41.

As shown in FIG. 2D, track 40b′ is not aligned with bottom edge 46b of slot 41. This is also in contrast to the embodiment discussed above in FIG. 2B. Track 40b′ intersects with bottom edge 46b at step 50, which provides a mechanism for securing filter medium 12 in front frame 24. When filter medium 12 slides into slot 41, filter medium 12 drops into track 40b′ after passing step 50. Filter medium 12 is then secured in front frame 24 by step 50. Merely pulling filter frame 12 in a lateral direction will not remove it from front frame 24. Instead, to remove filter medium 12, a user must first lift filter medium 12 to clear step 50, and then laterally pull filter medium 12 out of front frame 24.

In addition to the embodiment discussed in FIG. 2D, filter medium 12 may be removably secured in front frame 24 in a variety of manners. For example, right wall 32 may include a cover panel (not shown) that encases slot 41 after filter medium 12 is fully inserted. The cover panel may be a latch or hinged door that may open and close to provide access to slot 41. For example, the cover panel may be an auto-closing panel similar to those for PCMCIA card slots. The cover panel may also be an external casing that aesthetically matches display panel 18, and which is manually attachable to right wall 32.

In other alternative embodiments, front frame 24 may provide a frictional fit for filter medium 12 at a location adjacent left wall 30. For example, in one embodiment, the distance between tracks 40a and 40b decreases as tracks 40a and 40b approach left wall 30. That is, a first distance measured between tracks 40a and 40b adjacent left wall 30 is less than a second distance measured between tracks 40a and 40b adjacent right wall 32. The difference between the first distance and the second distance only needs to provide a snug fit with the top and bottom edges of filter medium 12. The frictional fit will generally require a small amount of additional force to insert and remove filter medium 12 when leading edge 38 is adjacent left wall 30.

Alternatively, tracks 40a and 40b may each decrease in width as tracks 40a and 40b approach left wall 30, where the widths of tracks 40a and 40b are taken in direction that is perpendicular to the plane of screen 20. The decreasing widths of tracks 40a and 40b also provide a snug fit with the front and rear surfaces of filter medium 12.

FIGS. 2E and 2F are expanded views of section 2E in FIG. 2B, which illustrate additional embodiments for securing filter medium 12 into front frame 24. As shown in FIG. 2E, track 40a may include detent 51, which extends toward aperture 34. When filter medium 12 slides along tracks 40a and 40b, the top edge of filter medium 12 contacts detent 51, which compresses the top edge of filter medium 12. This creates a frictional fit between tracks 40a and 40b for filter medium 12. A similar arrangement may be used with track 40b of bottom wall 28 to additionally compress the bottom edge of filter medium 12.

As shown in FIG. 2F, track 40a may include notch 52, which extends away from aperture 34. Notch 52 is a recessed portion in track 40a, which is capable of receiving a detent located on the top edge of filter medium 12 when filter medium 12 is inserted into front frame 24. When filter medium 12 slides along tracks 40a and 40b, the detent on the top edge of filter medium 12 inserts into notch 52. This also creates a frictional fit for filter medium 12. A similar arrangement may be used with track 40b of bottom wall 28 to match with a second detent located on the bottom edge of filter medium 12.

FIGS. 2G-2J are front views of different embodiments of filter medium 12 for use with the embodiments of FIGS. 2A-2F (respectively referred to as filter media 12a, 12b, 12c, and 12d). Filter media 12a, 12b, 12c, and 12d each include leading edge 38 and trailing edge 53, where trailing edge 53 is the opposing edge from leading edge 38.

As shown in FIG. 2G, filter medium 12a also includes tab 54 on trailing edge 53. When filter medium 12a is fully inserted into slot 41 of display housing 18, tab 54 will extend into indentation 48. This provides a gripping surface for a user to remove filter medium 12a from display housing 18. Tab 54 is also off-centered to align with indentation 48. As discussed above, this allows a user to recognize which surface of filter medium 12a should be facing the user during use.

As shown in FIG. 2H, filter medium 12b includes tab 54 on trailing edge 53, and also includes tab 55 on leading edge 38 for assisting in the removal of filter medium 12b from display housing 18. Tab 54 functions in the manner discussed above in FIG. 2G. Tab 55, however, may be used with a second indentation (not shown in FIG. 2B) that is disposed in left wall 30. The second indentation and tab 55 allow a user to dislodge filter medium 12b from front frame 24 by pressing tab 55 in a direction toward aperture 34. This moves filter medium 12b in the same direction. The movement of filter medium 12b forces trailing edge 53 of filter frame 12b to extend out of slot 41, which provides a grip for the user. Tab 54 and tab 55 may be offset with respect to each other in the vertical direction to allow a user to recognize which surface of filter medium 12b should be facing the user during use.

As shown in FIG. 2I, filter medium 12c includes tab 54 on trailing edge 53, and notch 56 located in a bottom corner, adjacent trailing edge 53. Tab 54 functions in the manner discussed above in FIG. 2G. Notch 56 allows filter medium 12c to be secured in front frame 24 having step 50, as discussed above in FIG. 2C. When filter medium 12c is fully inserted in front frame 24, notch 56 aligns with the step 50 and bottom edge 46b of slot 41. This allows the portion of filter medium 12c that is adjacent trailing edge 53 to remain in slot 41, for removing filter medium 12c, as discussed above.

As shown in FIG. 2J, filter medium 12d includes tab 54 on trailing edge 53, and detents 57 located on the top and bottom edges of filter medium 12d, adjacent leading edge 38. Tab 54 functions in the manner discussed above in FIG. 2G. Detents 57 provide a frictional fit between filter medium 12d and notches 52 of tracks 40a and 40b, as discussed above in FIG. 2F. This provides a frictional fit for filter medium 12, and identifies when filter medium 12 is fully inserted in front frame 24.

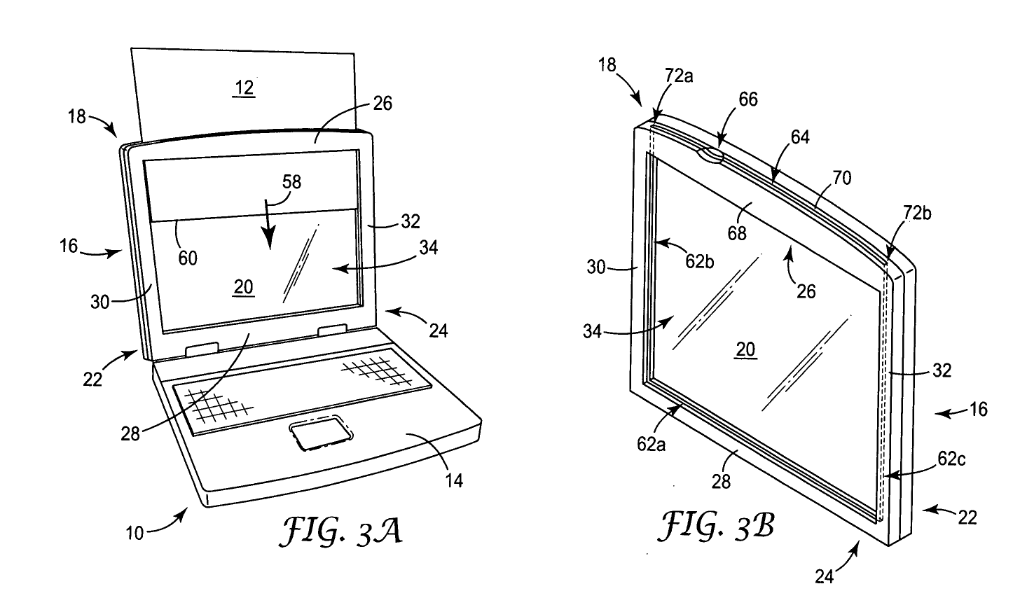

FIG. 3A is a front perspective view of notebook computer 10 including display 16 constructed according to an exemplary embodiment of the present disclosure, showing filter medium 12 being inserted through top wall 26 of front frame 24. This is noted by directional arrow 58. As shown, filter medium 12 includes leading edge 60, which slides through top wall 26 and into aperture 34, until filter medium 12 is disposed in front of screen 20. In this embodiment, filter medium 12 may be removably retained in front frame 24 in a similar manner as discussed above for the side-insertion embodiment in FIG. 2A. In contrast to the side-insertion embodiment, the present embodiment is useful where a locking mechanism (not shown) for closing notebook computer 10 is located on left wall 30 and/or right wall 32 of display housing 18.

FIG. 3B is a top perspective view of display 16, and further illustrates the exemplary embodiment of FIG. 3A. As shown, front frame 24 includes tracks 62a-62c and slot 64, all of which are integrally formed in front frame 24, rear housing portion 22, or between rear housing portion 22 and front frame 24. Display housing 18 also includes indentation 66, which functions in the same manner as indentation 48 for removing filter medium 12. Tracks 62a-62c respectively extend along the inner perimeters of bottom wall 28, left wall 30, and right wall 32 within aperture 34 (track 62c is shown by phantom lines). Top wall 26 of front frame 24 includes front surface 68 adjacent aperture 34, and side surface 70 adjacent rear housing portion 22. Slot 64 extends through top wall 26 from side surface 70, and into aperture 34. Slot 64 includes left end 72a that aligns with track 62b and right end 72b that aligns with track 62c.

Filter medium 12 may be inserted and removably retained in slot 64 in a similar manner to that discussed above for the side-insertion embodiments of FIGS. 2A-2J, except in a direction along directional arrow 58. When filter medium 12 is fully inserted into front frame 24, filter medium 12 visually appears as part of display housing 18, which preserves the aesthetic qualities of display 16.

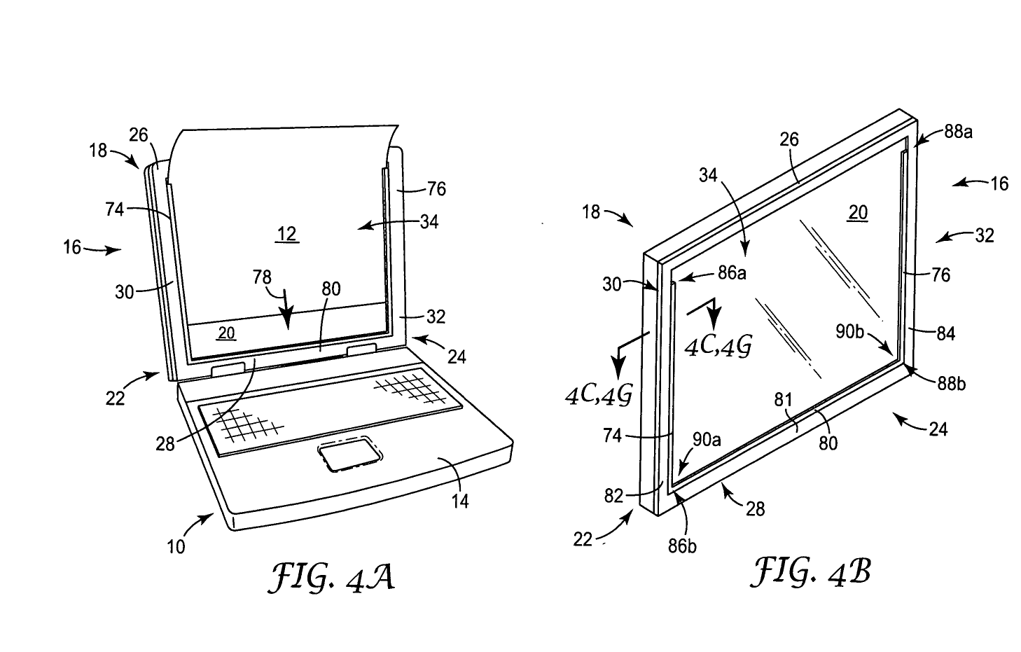

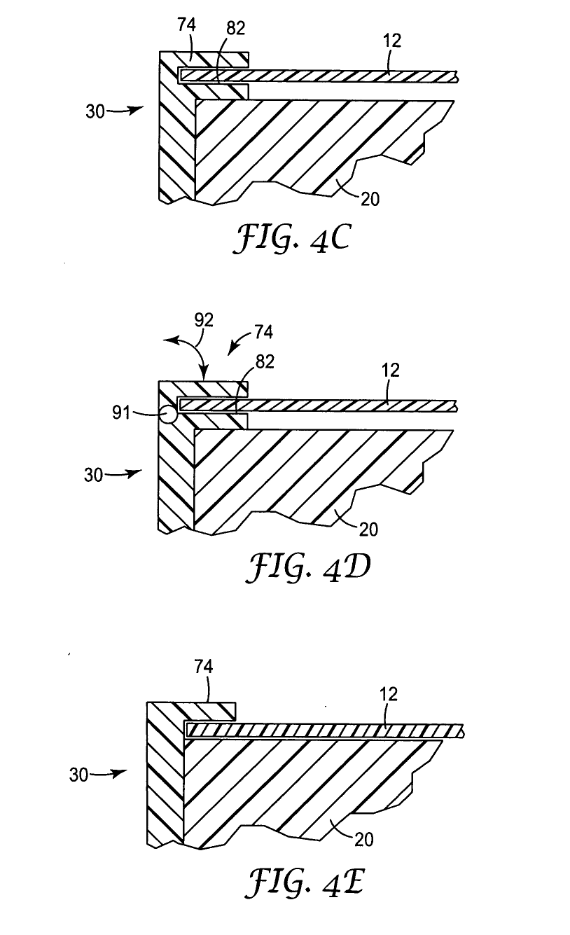

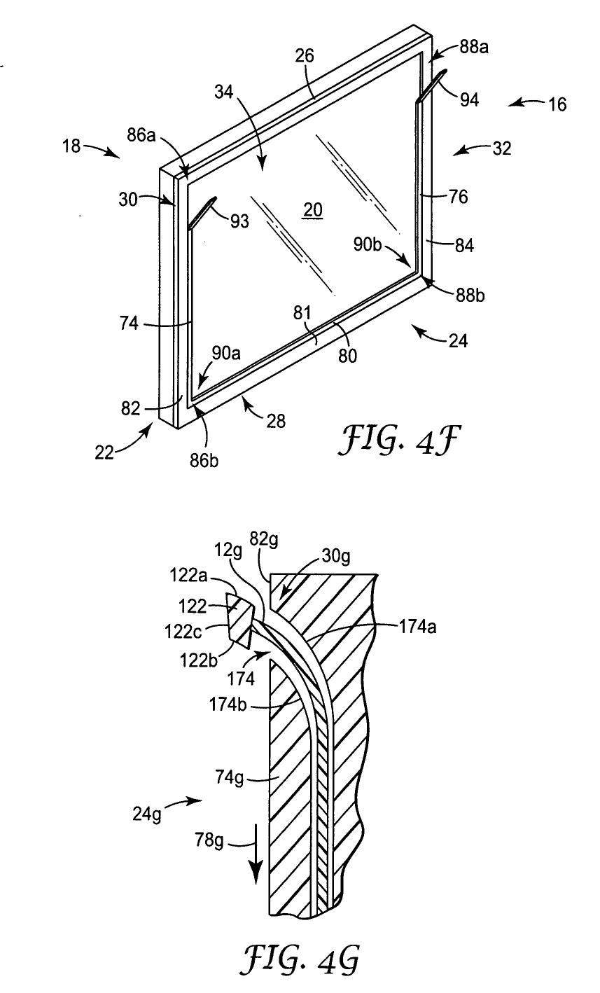

FIG. 4A is a front perspective view of notebook computer 10 including display 16 constructed according to another exemplary embodiment of the present disclosure, showing filter medium 12 being inserted through guide rails 74 and 76, which respectively extend from left wall 30 and right wall 32 of front frame 24. The insertion direction of filter medium 12 is noted by directional arrow 78. In this embodiment, filter medium 12 is initially fed to front frame 24 at an angle to screen 20. Filter medium 12 is then bent to feed filter medium 12 in a direction that is substantially parallel to screen 20. This differs from the previous embodiments discussed above, which do not require filter medium 12 to be fed to front frame 24 at an angle to screen 20. However, the present embodiment also allows filter medium 12 to be removably retained in front frame 24, thereby allowing it to be removed and inserted when desired and multiple filter media to be interchangeably used with display 16.

FIG. 4B is a front perspective view of display 16, further illustrating the embodiment of FIG. 4A. As shown, front frame 24 includes guide rails 74 and 76, and receiving rail 80, all of which may be integrally formed with front frame 24. Bottom wall 28 includes front surface 81, left wall 30 includes front surface 82, and right wall 32 includes front surface 84. Guide rail 74 includes top end 86a and bottom end 86b, and extends in a substantially parallel manner along front surface 82 of left wall 30, between top end 86a and bottom end 86b. Similarly, guide rail 76 includes top end 88a and bottom end 88b, and extends in a substantially parallel manner along front surface 84 of right wall 32, between top end 88a and bottom end 88b. Receiving rail 80 includes left end 90a and right end 90b, and extends in a substantially parallel manner along bottom wall 28 between left end 90a and right end 90b.

Filter medium 12 is inserted into front frame 24 by sliding the leading corners of filter medium 12 into guide rails 74 and 76. As such, the leading corner of filter medium 12 adjacent left wall 30 slides between guide rail 74 at top end 86a and portion of surface 82 of left wall 30. Similarly, the leading corner of filter medium 12 adjacent right wall 32 slides between guide rail 76 at top end 88a and portion of surface 84 of right wall 32. Filter medium 12 then slides down guide rails 74 and 76 until the leading corners of filter medium 12 exit at bottom ends 86b and 88b where the guide rails 74 stop short of the bottom wall 28. Where the guide rails 74 extend all the way to the bottom wall 28 or are formed integrally with the bottom wall 28, the leading corners of filter medium 12 are retained beneath bottom ends 86b and 88b. Guide rails 74 and 76 retain filter medium 12 such that filter medium 12 is substantially parallel to screen 20 when exiting guide rails 74 and 76 at bottom ends 86b and 88b or when retained beneath bottom ends 86b and 88b. Filter medium 12 is fully inserted in front frame 24 when receiving rail 80 is reached and entered. In such a case, filter medium 12 slides under receiving rail 80 and over screen 20. When filter medium 12 is fully inserted into front frame 24, filter medium 12 visually appears as part of display housing 18.

Guide rails 74 and 76, and receiving rail 80 may alternatively have different lengths than those shown in FIG. 4B. For example, guide rails 74 and 76 may each have any suitable lengths that extend between top wall 26 and bottom wall 28. Similarly, receiving rail 80 may have any suitable length that extends between left wall 30 and right wall 32. In one particular embodiment, as explained above, guide rail 74 may extend substantially along the entire inner perimeter of left wall 30, guide rail 76 may extend substantially along the entire inner perimeter of right wall 32, and receiving rail 80 may extend substantially along the entire inner perimeter of bottom wall 28. In this case, guide rails 74 and 76 connect with receiving rail 80 at the bottom corners of aperture 34. This creates a set of tracks that are similar to tracks 62a-62c in the embodiment discussed above in FIGS. 3A and 3B. However, in the present embodiment, filter medium 12 remains exposed at top wall 26 for removal.

To hide the exposure at top wall 26, filter film 12 may include a frame portion along the top edge of filter medium 12, where the frame portion aesthetically matches front frame 24. When filter medium 12 is fully inserted into front frame 24 as discussed above in FIGS. 4A and 4B, the frame portion along the top edge of filter medium 12 extends across top wall 26. This creates an integral look for top wall 26, and hides the top edge of filter medium 12.

FIG. 4G is a partial cross-sectional view of an exemplary embodiment of a top portion of a guide rail 74g extending from a wall 30g of front frame 24g and a portion of filter medium 12g. The insertion direction of filter medium 12g under guide rail 74g is noted by directional arrow 78g. In this exemplary embodiment, filter medium 12g is initially fed into an opening 174 at an angle to screen 20. The opening 174 may have a sloped wall 174a and an opposing sloped wall 174b, which may be configured so that a distance between the walls 174a and 174b decreases in the direction of the arrow 78g to form a two-dimensional funnel for increased ease of inserting the filter medium 12g. The filter medium may include a top frame portion 122 attached to or framing the top portion of the filter medium 12g. In some exemplary embodiments, sides 122a and 122b of the top frame portion 122 are dimensioned and configured to fit within the opening 174. The outer end 122c of the top frame portion 122 may be dimensioned and configured to form a substantially planar surface, which is preferably parallel to the front surface 82g of the front frame 24g, when the filter medium is fully inserted under the guide rail 74g.

FIGS. 4C-4E are sectional views of section 4C-4C in FIG. 4B, which illustrate other exemplary embodiments for inserting filter medium 12 in guide rail 74 of left wall 30. While the discussion in FIGS. 4C-4E focus on guide rail 74 and left wall 30, it may apply equally to guide rail 76 and right wall 32, and to receiving rail 80 and bottom wall 28. FIG. 4C further illustrates the embodiment discussed in FIG. 4B, and shows filter medium 12 removably retained between guide rail 74 and a portion 82 of left wall 30. As such, filter medium 12 is disposed close to the front of screen 20 for filtering the output of screen 20 during use.

FIG. 4D illustrates an alternative embodiment to that shown in FIG. 4C, in which guide rail 74 is pivotally connected to left wall 30 by hinge 91. Hinge 91 may be a living hinge or a conventional hinge that allows guide rail 74 to pivotally open and close, as depicted by directional arrow 92. This allows filter medium 12 to be inserted into front frame 24 without sliding filter medium 12 from top wall 26. Instead, a user may insert and remove filter medium 12 by merely opening and closing guide rails 74 and 76.

FIG. 4E illustrates another alterative embodiment to that shown in FIG. 4C, in which left wall 30 does not include a portion 82 shown in FIG. 4C. Bottom wall 28 and right wall 32 respectively also do not include such additional portions. As such, filter medium 12 may be inserted directly between screen 20 and guide rail 74. This places filter medium 12 at a close proximity to screen 20, and is beneficial for use with filter media that are more effective when positioned close to screen 20.

FIG. 4F is a front perspective view of display 16, illustrating another alternative embodiment for guide rails 74 and 76. As shown, front frame 24 may also include hinged rail portions 93 and 94, which are pivotally connected to guide rails 74 and 76 at top ends 86a and 88a, respectively. Hinged rail portions 93 and 94 are capable of opening and closing to provide access for inserting filter medium 12 in guide rails 74 and 76. To insert filter medium 12, hinged rail portions 93 and 94 are opened, and filter medium 12 is inserted into guide rails 74 and 76, as discussed above in FIG. 4B. When filter medium 12 is fully inserted, the hinged rail portions 93 and 94 may be closed to secure filter medium 12 in front frame 24 and to provide a more integral look. The hinged portions 93 and 94 may be living hinges. In some exemplary embodiments, hinged portions 93 and 94 can extend all the way to the top wall 26, so that the ends 88a and 88b are disposed adjacent the top wall 26. In other exemplary embodiments, hinged portions 93 and 94 can extend to overlap with top wall 26, so that the ends 88a and 88b can be disposed under a portion of the top wall 26.

FIG. 5 is a front perspective view of notebook computer 10 including another exemplary display 16 constructed according to the present disclosure, showing filter medium 12 being inserted under or behind tabs 95 of front frame 24. Tabs 95 are integrally formed with front frame 24, and extend into aperture 34 from the center portions and corners of the inner perimeter of front frame 24. The present embodiment may alternatively include a differing number of tabs for retaining filter medium 12 in front frame 24.

Filter medium 12 may be inserted into front frame 24 by first inserting filter medium 12 behind tabs 95 along bottom wall 28. The remaining portion of filter medium 12 may then be placed substantially parallel to screen 20. The remaining edges of filter medium 12 are then pressed behind tabs 95. When fully inserted, filter medium 12 is disposed between the front edge of front frame 24 and screen 20. This embodiment also allows filter medium 12 to be removably retained in front frame 24.

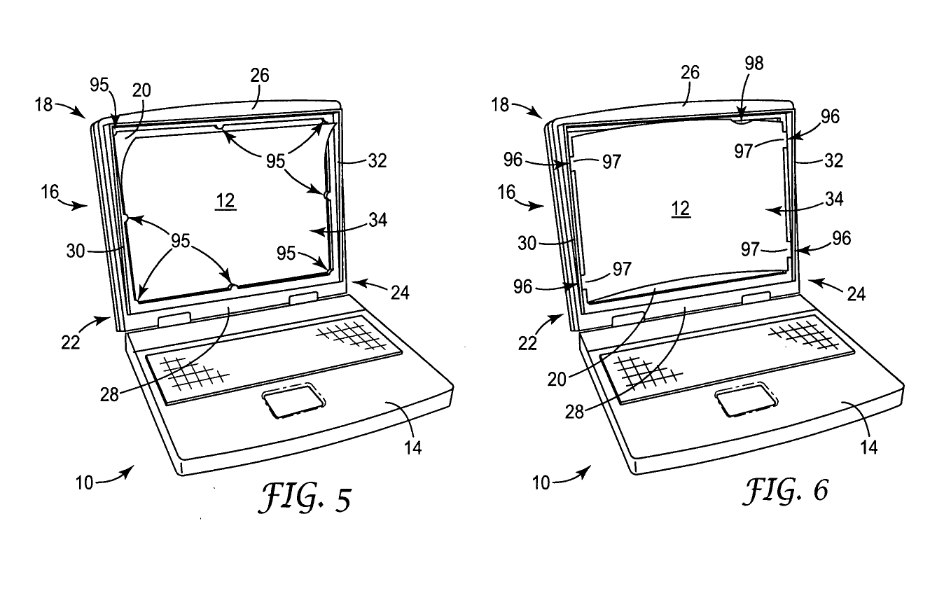

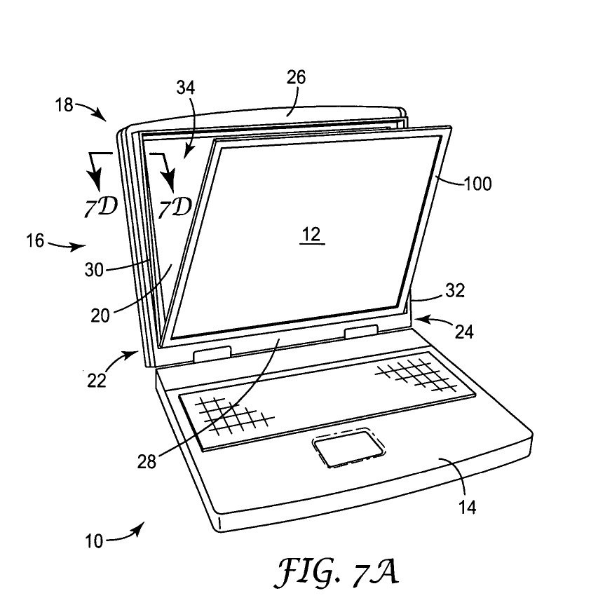

FIG. 6 is a front perspective view of notebook computer 10 including another exemplary display according to the present disclosure, showing filter medium 12 being inserted into notches 96 of front frame 24. Notches 96 extend in the left wall 30 and right wall 32 of front frame 24, adjacent top wall 26 and bottom wall 28. Filter medium 12 includes corresponding tabs 97, which align with notches 96 when filter medium 12 is inserted. As further shown in FIG. 6, filter medium 12 also includes recessed portion 98 on a top surface of filter medium 12. The recessed portion 98 provides a gripping edge for removing filter medium 12 from front frame 24. In some exemplary embodiments, an indentation may be provided in the front frame for access to the filter medium edge.

Filter medium 12 may be inserted by bending filter medium 12 at a central location to orient tabs 97 at an angle to screen 20. Tabs 97 are then inserted into notches 96. Filter medium 12 is then adjusted to track the shape of screen 20. This positions filter medium 12 in aperture 34 of front frame 24 for use with screen 20. As with the previous exemplary embodiments, the present embodiment also allows filter medium 12 to be removably retained in front frame 24.

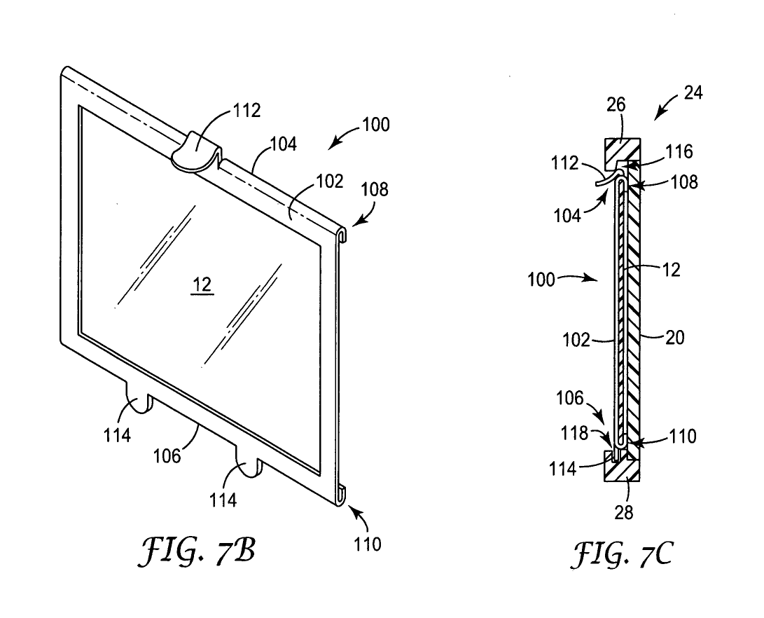

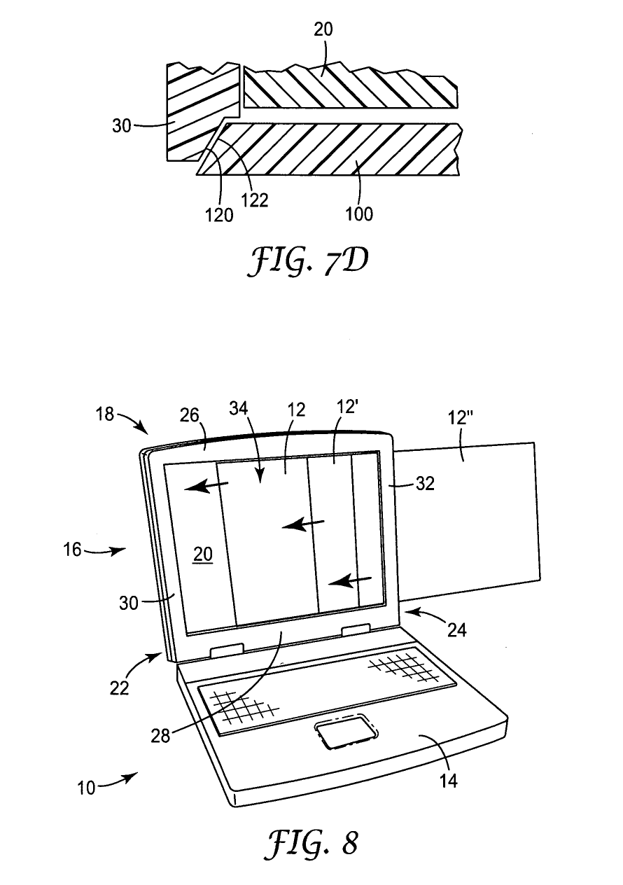

FIG. 7A is a front perspective view of notebook computer 10, showing frame insert 100 being connected to front frame 24, where frame insert 100 securely retains filter medium 12. Filter medium 12 may be securely retained in frame insert 100 in a variety of conventional manners (e.g., fasteners, adhesives, and heat sealing). The use of frame insert 100 with filter medium 12 can protect filter medium 12, for example, from coming in contact with a table top when removed, and provides a handling surface that prevents filter medium 12 from being smudged or otherwise marked-up. Frame insert 100 may be removably connected to front frame 24 in a variety of manners that allow frame insert 100 to be attached to front frame 24 during use, while also allowing frame insert 100 to be readily removed.

The present embodiment allows frame insert 100 to be used, or not used when desired, with display housing 18, or for different frame inserts to be used interchangeably. In the latter case, different filter media 12 may be interchangeably used with exemplary display 16 of notebook computer 10.

Examples of suitable mechanisms for removably connecting frame insert 100 to front frame 24 include locking mechanisms, frictional restraints, latching mechanisms, and combinations thereof. Examples of suitable locking mechanisms include magnetic contacts, removable adhesives, and removable fasteners. Examples of suitable fictional restraints include detents located on the outer perimeter of frame insert 100 and/or located on the inner perimeter of front frame 24.

In an alternative embodiment, frame insert 100 may be a thin border that closely matches the thickness of filter medium 12. In such an arrangement, frame insert 100 is also capable of sliding into display housing 18, pursuant to the embodiments discussed above in FIGS. 2A-4F. As such, frame insert 100 (with filter medium 12 retained therein) may slide into slots (e.g., slots 41 and 64) and along guide rails (e.g., guide rails 74 and 76), for placing filter medium 12 in front of screen 20. Frame insert 100 increases the rigidity of filter medium 12, and also provides a gripping surface so that a user does not smudge or otherwise mark up the surfaces of filter medium 12.

FIG. 7B is a front perspective view of frame insert 100 with filter medium 12 secured therein, which illustrates an example of a suitable latching mechanism for removably connecting frame insert 100 to front frame 24. As shown, frame insert 100 includes front surface 102, top edge 104, bottom edge 106, crimped portions 108 and 110, flexible tab 112, and insertion tabs 114. Crimped portions 108 and 110 are integral segments of front surface 102, which are folded over at top edge 104 and bottom edge 106, respectively, to retain filter medium 12. Flexible tab 112 is a semi-rigid tab that extends from top edge 104 of frame insert 100. Insertion tabs 114 are rigid members that extend from bottom edge 106 of frame insert 100. Flexible tab 112 and insertion tabs 114 are mechanisms for removably connecting frame insert 100 to front frame 24.

FIG. 7C is a side sectional view of front frame 24, showing frame insert 100 retained in front frame 24, in front of screen 20. As shown, front frame 24 includes top notch 116 and bottom notch 118. Top notch 116 is a cavity that extends between top wall 26 and screen 20. Bottom notch 118 is a second cavity that extends between two members of bottom wall 28. Frame insert 100 may be inserted in front frame 24 by placing frame insert 100 at an angle to screen 20, and inserting insertion tabs 114 into bottom notches 118. Top edge 104 of frame insert 100 may then be pressed toward screen 20 until flexible tab 112 contacts top wall 26. An additional amount of force may then be applied to insert flexible tab 112 into top notch 116. Frame insert 100 is then removably retained in front frame 24. To remove frame insert 100, a user may pull on flexible tab 112 to dislodge flexible tab 112 from top notch 116. Frame insert 100 may then be readily removed.

FIG. 7D is a sectional view taken of section 7D-7D in FIG. 7A with the frame insert in place, which illustrates an alternative design for front frame 24 and frame insert 100. As shown, left wall 30 of front frame 24 has a tapered edge 120 and frame insert 100 has a corresponding tapered edge 122. When frame insert 100 is connected to front frame 24, tapered edges 120 and 122 align to hide the gap between left wall 30 and frame insert 100. A similar arrangement may be used along the remaining outer edges of frame insert 100, and the inner edges of top wall 26, bottom wall 28, and right wall 32 of front frame 24. This preserves the aesthetic qualities of display housing 18, and creates a moderate frictional fit between front frame 24 and frame insert 100. Additionally, the tapered edges of front frame 24 (e.g., tapered edge 120) provide a wide entrance for frame insert 100 that reduces the alignment accuracy required to insert frame insert 100 into front frame 24.

FIG. 8 is a front perspective view of notebook computer 10 including an exemplary display 16 constructed according to the present disclosure, showing multiple filter media being inserted through right wall 32 of front frame 24. The retaining components discussed above for receiving and holding filter medium 12 in front of screen 20 are depicted in use with a single filter medium 12. However, the retaining components may also exhibit dimensions for receiving and holding multiple filter media. FIG. 8 illustrates an example of this. As shown, three filter media (i.e., filter media 12, 12′, and 12″) are removably inserted into slot 41 in a similar manner to that discussed above in FIGS. 2A and 2B for filter medium 12. This allows three filter media to simultaneously filter the output of screen 20. Alternatively, display housing 18 may include multiple retaining components (e.g., multiple slots 41), which also allow multiple filter media to be disposed in front of screen 20 in a similar manner.

In addition to the retaining components discussed above for receiving and holding filter medium 12 in front of screen 20, computer base 14 and display housing 18 may also include additional retaining components for storing filter medium 12 when removed or spare filter media. The additional retaining components may be located adjacent or in rear housing portion 22 behind screen 20 and/or in or under computer base 14. For example, rear housing portion 22 may include a slot and tracks similar to slot 41 and tracks 40a-40c, which receiving and hold spare filter media behind screen 20. In another example, a retaining component may be located on the bottom surface of base computer 14. The additional retaining components allow filter medium 12 or additional filter media to be readily available for interchangeable use. Any of the above-discussed embodiments may be applied to notebook computer 10 for storing additional filter media behind screen 20 and/or to computer base 14.

While exemplary displays 16 are shown in the above embodiments as notebook computer displays, the present invention is not intended to be limited to notebook computer displays, and is applicable to any viewing device. Examples of suitable viewing devices for display 16 include television displays, notebook computer displays, desktop computer displays, handheld computer displays, and any other display that may benefit from the use of filter medium 12.

Rear housing portion 22 and front frame 24 may be manufactured from conventional display housing materials, such as plastics and metals. The retaining components described above are desirably manufactured integrally with display housing 18. However, in alternative embodiments of the present invention, the retaining components, such as guide rails 74 and 76 described above in reference to FIG. 4B, may be separate components that are secured to front frame 24. The components of display housing 18, including the retaining components may be manufactured with conventional molding and machining techniques.

Although the present invention has been described with reference to preferred embodiments, workers skilled in the art will recognize that changes may be made in form and detail without departing from the spirit and scope of the invention.

1. A display housing for use with a display screen, the display housing comprising:
a rear housing portion;
a front frame connectable to the rear housing portion, wherein the front frame defines an aperture through which the display screen is visible when the display screen is disposed between the front frame and the rear housing portion; and
a retaining component for removably retaining a filter medium between the display screen and a front edge of the front frame.

2. The display housing of claim 1, wherein the retaining component is integrally formed with the front frame, the rear housing portion, or between the front frame and the rear housing portion.

3. The display housing of claim 1, wherein the retaining component is configured for removably retaining a plurality of filter media.

4. The display housing of claim 1, wherein the retaining component comprises a plurality of guide rails for removably receiving a filter medium.

5. The display housing of claim 4, wherein the front frame comprises a left wall having a first guide rail, a right wall having a second guide rail, and a bottom wall comprising a receiving rail, wherein the first guide rail, the second guide rail and the receiving rail are configured for removably receiving one or more filter media.

6. The display housing of claim 5, wherein the first and second guide rails each comprise hinged top portions.

7. The display housing of claim 5, wherein the first guide rail is connected to the left wall by a first hinge and the second guide rail is connected to the right wall by a hinged portion.

8. The display housing of claim 1, wherein the retaining component comprises a plurality of notches for removably receiving the filter medium, wherein the filter medium comprises a plurality of tabs that align with the notches when the filter medium is retained by the display housing.

9. The display housing of claim 1, wherein the retaining component comprises a plurality of tabs for removably receiving a filter medium under the tabs.

10. The display housing of claim 1, further comprising a frame insert that is removably connectable to the display housing, wherein the filter medium is disposed within the frame insert.

11. The display housing of claim 10, wherein the display housing further comprises a first tapered edge, wherein the frame insert comprises a second tapered edge, and wherein the first tapered edge aligns with the second tapered edge when the frame insert is connected to the display housing.

12. The display housing of claim 1, wherein the rear housing portion comprises at least one additional retaining component for retaining one or more filter media behind the display screen.

13. A display housing for use with a display screen, the display housing comprising:
a rear housing portion;
a front frame connectable to the rear housing portion, wherein the front frame defines an aperture through which the display screen is visible when the display screen is secured between the front frame and the rear housing portion; and
a retaining component integrally formed with the display housing for removably retaining a filter medium adjacent the display screen.

14. The display housing of claim 13, wherein the retaining component is configured for removably retaining a plurality of filter media.

15. The display housing of claim 13, wherein the retaining component comprises a plurality of rails for removably receiving the filter medium.

16. The display housing of claim 15, wherein the front frame comprises a left wall having a first guide rail, a right wall having a second guide rail, and a bottom wall comprising a receiving rail, wherein the first guide rail, the second guide rail and the receiving rail are configured for removably receiving one or more filter media.

17. The display housing of claim 16, wherein the first and second guide rails each comprise hinged top portions.

18. The display housing of claim 13, wherein the retaining component comprises a plurality of tabs for removably receiving a filter medium under the tabs.

19. A display system comprising:
a display housing comprising a rear housing portion and a front frame connectable to the rear housing portion, the front frame having a perimeter that defines an aperture;
a display screen disposed in the display housing such that the display screen is visible through the aperture;
a retaining component incorporated into the display housing for removably retaining a filter medium adjacent the display screen such that the filter medium is disposed in front of the viewing surface of the display screen.

20. The display housing of claim 1, wherein the retaining component is configured for removably retaining a plurality of filter media.

21. The display system of claim 19, wherein the display housing comprises a frame insert that is removably connectable to the display housing, wherein the filter medium is disposed within the frame insert.

22. The display system of claim 19, wherein the rear housing portion comprises a second retaining component for retaining filter media behind the display screen.

23. The display system of claim 19, further comprising a computer base, wherein the computer base comprises at least one additional retaining component for removably retaining filter media.
